(19) United States
(12) Patent Application Publication
(10) Pub. No.: US 2006/0266704 A1
(43) Pub. Date: Nov. 30, 2006

(54) Biological filtration module for use within a wastewater treatment system

(76) Inventors: Thomas D. Murphy, Reno, NV (US); Ingchen Douglas Hwang, Waukesha, WI (US)

Correspondence Address: Thomas D. Murphy, 7630 Tholl Drive, Reno, NV, 89506, US

(21) Appl. No.: 11/441,373

(22) Filed: May 25, 2006

Related U.S. Application Data
(60) Provisional application No. 60/684,920, filed on May 25, 2005.

(51) Int. Cl. C02F 3/02

(52) U.S. Cl. 210/626

(57) ABSTRACT

A modification module which when installed within a wastewater treatment system eliminates the need for a typical floating decanter and associated components therewith. The present module can be a retrofit and easily installed within a pre-existing system. Whereby, the time and requirements needed to enable idle, settle and intermittent decant modes of a fill and draw process operation are eliminated and the resultant effluent is of zero pollutant. Furthermore, the present module when installed within the system greatly reduces cost, as very little electricity is required for function due to gravitational filtration as opposed to standard systems that require suction and associated pump(s), circuitry and the like.

### RELATED PRIOR ART

This application pertains to our provisional application No. 60/684,920 that was filed on May 25, 2005 in the names of the present inventors, which as of now is being converted in a timely manner into a utility application accordingly.

### FIELD OF THE INVENTION

This invention relates in general to wastewater treatment systems but more particularly pertains to a system wherein a modification module eliminates the need for a typical floating decanter and associated components therewith. The present module can be a retrofit and easily installed within a pre-existing system. Whereby, the time and requirements needed to enable idle, settle and intermittent decant modes of a fill and draw process operation are eliminated and the resultant effluent is of zero pollutant. Furthermore, the present module when installed within the system greatly reduces cost, as very little electricity is required for function due to gravitational filtration as opposed to standard systems that require suction and associated pump(s), circuitry and the like.

### BACKGROUND OF THE INVENTION

There have been numerous attempts within the known prior art to provide efficient and environmentally friendly wastewater treatment systems. However, such prior art includes inherent disadvantages and drawbacks that the present invention recognizes, addresses and resolves in a manner heretofore not taught.

For example, within all of the known prior art, “idle”, “settle”, and “decant” sequences are essential for function and this type of operation has proven to be most inefficient and very costly. U.S. Pat. Nos. 5,104,528, 4,278,541, 4,230,578, and 2,140,059 are all exemplary of typical wastewater treatment systems incorporating floating decanters and the like.

Within the known prior art there are basically three variable types of wastewater treatment systems. The first being a biological wastewater treatment process whereby there are suspended growth methods, in which suspended microorganisms are utilized. According to this technique, wastewater and microorganisms are mixed in a reaction tank as air is supplied within the reaction tank, thereby facilitating contact between wastewater and microorganisms. The microorganisms present in the reaction tank are capable of removing pollutants using oxygen contained in the air supplied. A sequencing batch reactor (SBR) technique is one of the suspended growth methods wherein wastewater to be treated is filled in a reactor tank up to a predetermined inflow level and the wastewater is aerated using an aerator while stirring, to permit a reaction to occur. Thereafter when the reaction is completed, sludge is precipitated, and supernatant liquid is decanted until the level of the reaction tank becomes an outflow level and then discharged. Then, before new wastewater is introduced into the reaction tank, the operation of the sequencing batch reactor is idled for a predetermined time in order to adjust a cycling time.

The SBR technique is a modified sequencing activated sludge process, in which an unsteady environmental pressure is applied to microbe consortia in a reaction tank for microbial selection, for overcoming problems arising from a heavy impact load, which may be generated during a sequencing activated sludge process, sedimentation from a settling reservoir and an increase in the settlement site area due to a secondary settling reservoir.

The SBR technique has advantages in terms of excellent impact absorbing ability and excellent sludge sedimentation capability. However, the SBR technique has the following problems and disadvantages.

First, the SBR technique involves complicated steps, including, wastewater filling, reaction, settlement, discharging and idling, requiring a long cycling time.

Second, a floating decanter and associated complicated circuitry and/or pump(s) for discharging treated water are required, which is economically inefficient and poor in stability.

Third, flow control is difficult due to a long cycling time.

Fourth, an objectionable smell is resultant and floating scum is generated, making liquid-solid separation difficult.

Fifth, sludge may not be easily drained during discharge or decanting.

Another biological wastewater treatment process includes a sequencing biological filtering method. Wherein de-nitrification within the wastewater is incurred. First, wastewater to be treated is introduced into a lower chamber through a wastewater supply means of a de-nitrification tank in an anoxic condition and is allowed to upwardly pass through a filter medium layer. Here, nitrate nitrogen returned from a nitrification tank through an internal returning means is denitrified using organic matter in the wastewater and denitrifying microorganisms inhabiting in the filter medium layer. Thereafter, the wastewater having passed through the de-nitrification tank is introduced into a lower chamber of the nitrification tank through a first discharging means. In this case, air is supplied to the nitrification tank through a process air introducing means. The wastewater introduced into the lower chamber is allowed to upwardly pass though the filter medium layer. Resulting in organic nitrogen and ammonium nitrogen contained therein to then become nitrified by nitrifying microorganisms.

Finally, the treated wastewater having passed through the nitrification tank is discharged to a separate storage tank through a second discharging means. The completely treated water is then discharged from the storage tank. During backwashing, the treated water is introduced to the lower chamber of the de-nitrification tank and the lower chamber of the nitrification tank through a backwash water introducing means to wash the filter medium layers. Then, the wastewater used in backwashing is discharged to the sedimentation tank or settling reservoir by a backwash water discharging means.

According to the sequencing biological filtering method implemented in the above-described manner, the wastewater can be effectively treated in terms of cost and performance since both physical filtering by a filter medium layer and biodegradation by microorganisms inhabiting in the filter medium layer are used for wastewater treatment. Unlike in a sequencing physical filtering method in which only physical filtering by a filter medium is used.

Yet the sequencing biological filtering method has several problems. First, biological removal of phosphorus due to phosphorus release and excessive uptake mechanism of a microbe membrane is impossible.

Second, nitrogen and phosphorus cannot be simultaneously removed in a single reaction tank.

Third, for the foregoing reason, at least two reaction tanks are required for wastewater treatment.

Fourth, clogging may be liable to occur to a filter medium layer, making it difficult to be suitably applied to high-concentration wastewater.

A third type of wastewater treatment system is taught in U.S. Pat. No. 5,186,821 which is currently the most advanced and advantageous system available today. This system utilizes only one reactor tank that has no compartments but includes a first flow equalization collector surrounded by a cylindrical partition that virtually eliminates hydraulic turbulence and creates a pre-strat zone. Also, a floating decanter is incorporated and programmable circuitry including timing of aeration, liquid levels and decanting processes with the results of producing a quality supernatant affluent in a simplified system.

Although the last described wastewater system is highly advanced when compared to the other systems, the use of a floating decanter and associated circuitry is still not cost effective and thus the need for improvement is still great.

### OBJECTS AND ADVANTAGES OF THE INVENTION

To resolve the above-described problems, it is an object of the present invention to provide a cyclic style wastewater treatment apparatus using a biological and physical filtering and decanting module. The module may be easily incorporated into substantially any pre-existing wastewater system as a retrofit with little modification being required.

A very important object of the present invention is to provide a filtering/decanting module that when installed eliminates the need for clarifiers, a floating decanter, pump(s) and expensive electrical components associated with prior art systems.

Another very important object of the present invention is that typical prior art systems do not allow the reactor tank of the system to operate at a continuous optimum top water level as taught by the present invention. This is most advantageous as this provides peak performance and increases oxygen transfer, which in turn greatly reduces energy usage and requirements.

Still further within the prior art the use of an ultra filter membrane is typical and standard. However, this type of filter is not feasible or cost effective and does not provide superior process and decant benefits such as achieved by the present micro filter decant module as will later be seen herein.

Also, the improved micro filter decant module of the present invention eliminates the need for additional filtration external the reactor as required with other types of systems. More importantly an ultra membrane must be replaced periodically and this is very costly. The present micro filter medium is much more durable, functional, more efficient, less costly, and the life span is much greater.

Yet another advantage of the present invention is that filtration is gravitational as opposed to traditional ultra membrane filtration requiring suction pump(s) etc.

And yet another advantage provided by the present invention is its ability to be installed into existing municipal treatment plants which receive combined sewer and storm water flows. Currently, these large plants loose their process biomass in washout conditions during large rainfalls. It takes weeks for the biomass population to reestablish itself before acceptable treatment levels are met. In the meantime, raw and untreated sewage flow into and pollute our nation's waterways. The present invention will not allow the process biomass of these systems to flow out of these systems. The biomass is caught and returned to the reactor basin by the present invention thereby preventing the pollution from occurring after these storms. The current invention can handle increased flow rates of many times a system's average flow that allows this advantage to be realized. The traditional ultra membrane filtration does not have the flexibility to operate at increased flow rates. Systems of the traditional ultra membrane filtration will allow overflow and washout similar to other traditional systems. Until this current invention, there has been no solution to this problem.

Additionally, this current invention can be installed in aeration basins of conventional systems having secondary clarifiers thereby eliminating secondary clarifiers and all the energy and problems associated with them.

And then one of the most outstanding advantages is the additional biological treatment steps realized with the current invention that are not realized by the decanter or the ultra membrane systems. The current invention additionally treats the effluent by allowing it to pass through the plate clarification pack where additional treatment of the effluent is realized through the attached growth biological degradation that occurs on the surface areas of the packs. Following this step, the additionally treated effluent is then exposed to the micro filter cloth media that provides additional treatment and guaranteed solids removal down to at least 40 microns in size or even less if necessary.

And still another advantage of the current invention as compared to the ultra membrane systems is the micro filter of this current invention, only interfaces with treated supernate having less than 5 ppm of biomass where the traditional ultra membrane must interface with biomass of 10,000 to 15,000 and suck supernate out of that concentration in effort to produce supernate of less than 5 ppm.

It is therefore contended a great need exists for a convenient, cost effective, reliable, feasible and simple to install module that easily replaces an existing floating decanter and ultra membrane system including expensive equipment associated therewith and thus provides unusual results and benefits not previously or currently attained within the known prior art.

Other objects and advantages will become apparent when taken into consideration the following specification and drawing description.

### BRIEF DESCRIPTION OF THE DRAWING

FIG. 1 is substantially a plan overview depicting one embodiment for incorporating use of the present invention within a new or pre-existing wastewater treatment system.

### DETAILED DESCRIPTION OF THE DRAWING

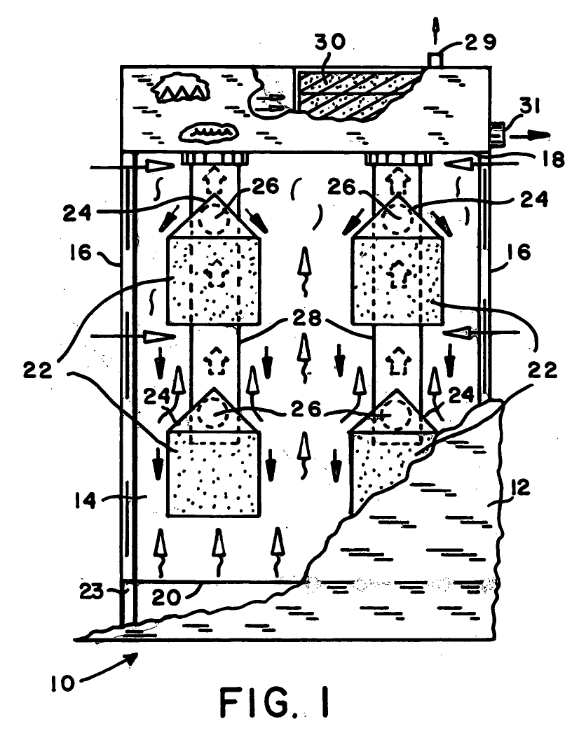

Referring now in detail to FIG. 1 wherein like characters refer to like elements throughout the drawing. As illustrated therein, (10) substantially represents an overview of the present invention when installed within a prior art wastewater treatment system such as previously described herein. It is to be understood any type of pre-existing wastewater system may be modified to accept the present invention. Thus, the drawing is exemplary of only one embodiment for installing the present invention within the prior art system, such as the system as taught within U.S. Pat. No. 5,186,821 or the like.

The noted prior art system provides a reactor tank (12) that is typically made either from cement, fiberglass, steel or the like. Also, the prior art system incorporates use of a floating decanter, ultra membranes, or secondary clarifiers and associated components thereof. Whereby, the present invention is a retrofit biological filtration module that replaces an existing decanter, ultra membranes, or secondary clarifiers and eliminates the need for expensive electronics and other components associated with those systems, thus greatly reducing operating and maintenance costs.

The general overview of this particular embodiment of the present invention includes a container module (14) made from any suitable material of engineering choice, such as steel or the like. The container module (14) comprising interconnected or integrally formed side walls (16), an enclosed top section (18), an open ended bottom section (20) and support means such as support legs (23) (only one shown for clarity purposes) but multiple legs are inherent. It is to be noted any suitable type of support means of engineering choice may be utilized. Thus, the invention is not to be limited to legs or the like.

The overall advantages and unusual results are mainly enabled and achieved due to the use of a newly developed biological media pack currently known as “PRO-PACK” and produced by PRO-Equipment, Inc, located in Waukesha, Wis. This newly developed media pack is substantially formed from bonded ABS thin wall plastic sheet material that is formed into novel multiple layers of equal spacing and alternate layers that crisscross to provide settling area, and are angled in opposite directions similar to an “egg crate” arrangement. This material proves to be most efficient and cost effective as it is extremely durable and it provides secondary coagulation and attached growth biological degradation in the lower portion of the micro decant module. Thus resulting with descending settled sludge creating a solids-contacting zone for the incoming solids to be flocculated/coagulated/captured and/or filtered. This material is further advantageous as it essentially requires no maintenance and accumulation of settled sludge is not anticipated.

This novel material is currently used in clarifiers such as those installed in wastewater treatment plants. However, the material has not been used and/or formed into a biological filtration unit suitable for installation directly into an aeration basin or reactor such as taught herein.

In the present invention the Pro-pack material is shaped into substantially a block thus forming the Pro-pack biological filtration unit (22). It is to be noted the wastewater treatment system may incorporate only one unit or as depicted herein multiples thereof are optional. The Pro-pack biological filtration unit further includes a cone-shaped cap (24) fixedly attached thereon by suitable attachment means of engineering choice, such as glue, epoxy, brackets, or the like. Cone shaped cap (24) further providing an internal passage (26) having an open end for delivering clarified water there through and into a conduit (28). Thereafter the clarified water can be directed there through for further processing such as by a micro-filter (30) or the like.

It can now be seen in operation; mixed liquor contained within the reactor (12) is directed in between the support legs (23) and flows upwardly into the container (14) via open bottom section (20). Thereafter, the mixed liquor is directed into the Pro-pack biological filtration and liquid solids separation unit(s) (22). The mixed liquor is then clarified and filtered therein by attached growth biological filtration. Namely, solid liquid separation is incurred as the solids due to biological growth and reaction accumulate thereon within the Pro-pack until gravity causes the solids to fall, see solid arrows. Simultaneously mixed liquid is forced into the Pro-pack biological filtration unit (22) and resultant clarified water is diverted into internal passage (26) and then delivered to conduit (28) for further processing such as a micro-filter (30) and associated components. The micro-filter then extracts all particulate matter greater than the micron size of the filter selected. The ex ted highly concentrated solids may then be directed back via a solids outlet (29) to the reactor (12) or to a solids management source, which ever is desired. The remaining treated and micro filtered supernate then exits via the supernatant outlet (31) from the biological micro filtration decant module (10).

Initially, liquid/solids separation occurs while adding an additional treatment step through an attached growth biological process which is followed by an additional physical treatment step of micro filtration thereby allowing for a final treatment step of disinfection and/or purification, maybe a final treatment step of the module.

It can now be seen we have herein provided a novel module that is substantially a retrofit and is usable within any pre-existing wastewater system of choice. The module eliminates the need for a decanter, clarifiers, complicated circuitry and associated pumps and the like. More importantly, the operating costs are much less when compared to all other related systems, the effluent is zero pollutant, and such a module has heretofore not been taught.

Although the invention has been herein shown and described in what is conceived to be the most practical and preferred embodiments, it is recognized that departures may be made there from within the scope and spirit of the invention, which is not to be limited to the details disclosed herein but is to be accorded the full scope of the specification and claims so as to embrace any and all equivalent devices and apparatus.

What we claim and wish to secure by Letters Patent is:

1. An established segregated area having support means and is created within a: reactor basin for treating of polluted waste water in which a mixed liquid and solids of a biological nature enter into said segregated area from the said reactor basin via a hydraulic communication means and said solids floc to settle out of the said liquid and return back to said reactor basin via gravity and non-mechanical hydraulic communication means while said liquid enters at least one filtration means for purification prior to said liquid exiting the segregated area and reactor basin as a purified water.

2. The segregated area of claim 1 may be referred to as a biological filtration module.

3. The biological filtration module of claim 1 offers accelerated clarification utilizing an plate clarification technology of a pro-pack media unit having a 60% sloped passages to cause enhanced clarification to occur allowing for a reduction of conventional industry standard settle rate time periods of at least five (5×) times.

4. The biological filtration module of claim 1 which offers sufficient liquid solids separation to allow incorporation of filtration means through which the liquid passes to be of a non-pollutant nature as a new water resource of a minimum quality of 100% removal of colloids and particulates larger than 10 nano meters, turbidity less than 0.1 NTU, over log 6 removal of (99.9999%) of bacteria, over log 4 removal of (99.9999%) of viruses and removal of large molecular weight organic compounds (above 1000,000 Daltons) before exiting said reactor so as to eliminate any discharge of said pollutants, this resulting in a produced water that meets the treated drinking water quality standards of the published United States Environmental protection Agency's Maximum Contaminant Level Goals (MCLG) prior to exiting said reactor.

5. The biological filtration module of claim 1 which activated sludge is return back to the reactor basin requiring no mechanical assistance.

6. The biological filtration module of claim 1 which will prevent overflow of process solids and process biomass out of a reactor basin during peak hydraulic flow periods such as a storm flow thereby keeping the process biomass retained within the reactor basin during said storm flow periods thereby providing for the immediate continued treatment of the incoming waste water following the said storm flow period.

7. A biological filtration module of claim 1 for use within a reactor tank associated with a wastewater treatment system comprising: a container module having side walls; an enclosed top section; an open ended bottom section; and support means; said container module having therein at least one pro-pack biological filtration unit, said pro-pack biological filtration unit having a cone-shaped cap attached thereon, said cone-shaped cap providing an internal passage, said internal passage having an open end for delivering a clarified water there through and into a conduit,
whereby:
when a mixed liquor contained with a reactor tank is directed in it flows upwardly into said container module via said open bottom section, said mixed liquor is then directed into said pro-pack biological filtration unit, said mixed liquor is then clarified and filtered therein by attached growth biological filtration, namely, solid liquid separation is incurred as the solids due to biological growth and reaction accumulate thereon within said pro-pack biological filtration unit until gravity causes said solids to fall returning back to the reactor basin, simultaneously mixed liquid is forced into said pro-pack resulting in clarified water which is then diverted into said internal passage and then delivered to said conduit for further processing.

8. The biological filtration module of claim 7 is suited for retrofit and is usable with any pre-existing wastewater treatment system having an aeration basin.

9. The biological filtration module of claim 7 is integrally formed within said reactor basin utilizing at least one reactor basin wall.

10. The biological filtration module of claim 7 wherein said further processing includes a micro-filter having a solids outlet and a supernatant outlet,
whereby:
said micro-filter extracts all particulate matter greater than the micron size of a filter selected, said solids may then be directed back via said solids outlet into said reactor or to a solids management source and said supernatant which is now treated and micro filtered exits said module via said supernatant outlet.

11. The biological filtration module of claim 7 wherein said further processing includes a micro-filter having a solids outlet and a supernatant outlet, whereby:
said micro-filter extracts all particulate matter greater than the micron size of a filter selected, said solids may then be directed back via said solids outlet into said reactor or to a solids management source and said supernatant which is now treated and micro filtered passes through a ultra violet purification channel and then exits said module via said supernatant outlet.

12. A biological filtration module for use within a reactor tank associated with a wastewater treatment system comprising: a container module having side walls; an open top section; an open ended bottom section; and support means; said module having therein at least one pro-pack biological filtration unit
whereby:
when a mixed liquor contained with a reactor tank is directed in from bottom section, it flows upwardly into said module via said open bottom section, said mixed liquor is then directed into said pro-pack biological filtration unit, said mixed liquor is then clarified and filtered therein by attached growth biological filtration, namely, solid liquid separation is incurred as the solids due to biological growth and reaction accumulate thereon within said pro-pack biological filtration unit until gravity causes said solids to fall, simultaneously mixed liquid is forced into said pro-pack resulting in clarified water which is then diverted into said internal passage and then delivered to said conduit for further processing by a micro-filter and said micro-filter having a solids outlet and a supernatant outlet,
whereby:
said micro-filter extracts all particulate matter greater than the micron size of a filter selected, said solids may then be directed back via said solids outlet into said reactor or to a solids management source and said supernatant which is now treated and micro filtered exits said module via said supernatant outlet,
whereby:
said biological filtration module providing a process of initiating clarification/particle management within said reactor which is not subject to disruption from the aeration process occurring within said reactor and provides for sludge return as a result of said particle management eliminating any need for a mechanical or mechanically motivated means, wherein this allows for a reduction of industry standard overflow rates of at least five (5×), said particle management prevents particle from exiting said reactor during excessive storm flow periods thus prevents passing of pollutants to a controlled level of 100% removal of colloids and particulates larger than 10 nano meters, turbidity less than 0.1 NTU, over log 6 removal of (99.9999%) of bacteria, over log 4 removal of (99.9999%) of viruses and removal of large molecular weight organic compounds (above 1000,000 Daltons) before exiting said reactor so as to eliminate any discharge of said pollutants, this resulting in a reclaimed and purified water that meets the treated drinking water quality standards of the published United States Environmental protection Agency's Maximum Contaminant Level Goals (MCLG) prior to exiting said reactor.

13. A biological filtration module for use within a reactor tank associated with a wastewater treatment system comprising: a container module having side walls; an open top section; an open ended bottom section; and support legs; said container module having therein at least one pro-pack biological filtration unit, said pro-pack biological filtration unit having a cone-shaped cap attached thereon, said cone-shaped cap providing an internal passage, said internal passage having an open end for delivering a clarified water there through and into a conduit,
whereby:
when a mixed liquor contained with a reactor tank is directed in between said support legs it flows upwardly into said container module via said open bottom section, said mixed liquor is then directed into said pro-pack biological filtration unit, said mixed liquor is then clarified and filtered therein by attached growth biological filtration, namely, solid liquid separation is incurred as the solids due to biological growth and reaction accumulate thereon within said pro-pack biological filtration unit until gravity causes said solids to fall, simultaneously mixed liquid is forced into said pro-pack resulting in clarified water which is then diverted into said internal passage and then delivered to said conduit for further processing by a micro-filter and said micro-filter having a solids outlet and a supernatant outlet,
whereby:
said micro-filter extracts all particulate matter greater than the micron size of a filter selected, said solids may then be directed back via said solids outlet into said reactor or to a solids management source and said supernatant which is now treated and micro filtered exits said module via said supernatant outlet,
whereby:
said biological filtration module providing a process of initiating clarification/particle management within said reactor which is not subject to disruption from the aeration process occurring within said reactor and provides for sludge return as a result of said particle management eliminating any need for a mechanical or mechanically motivated means, wherein this allows for a reduction of industry standard overflow rates of at least five (5×), said particle management prevents particle from exiting said reactor during excessive storm flow periods thus prevents passing of pollutants to a controlled level of 100% removal of colloids and particulates larger than 10 nano meters, turbidity less than 0.1 NTU, over log 6 removal of (99.9999%) of bacteria, over log 4 removal of (99.9999%) of viruses and removal of large molecular weight organic compounds (above 1000,000 Daltons) before exiting said reactor so as to eliminate any discharge of said pollutants, this resulting in a process that meets the limit for treated drinking water quality standards of the published United States Environmental protection Agency's Maximum Contaminant Level Goals (MCLG) prior to exiting said reactor thus producing reclaimed and purified water, a resource of value, which may be used for all beneficial uses common for any other treated water for potable household domestic uses.
